(19) United States
(12) Patent Application Publication
(10) Pub. No.: US 2008/0231912 A1
(43) Pub. Date: Sep. 25, 2008

(54) IMAGE PROCESSOR, IMAGE FORMING APPARATUS, IMAGE PROCESSING METHOD, AND COMPUTER PROGRAM PRODUCT

(75) Inventor: Akira MURAKATA, Tokyo (JP)

Correspondence Address: COOPER & DUNHAM, LLP, 1185 AVENUE OF THE AMERICAS, NEW YORK, NY, 10036, US

(73) Assignee: Ricoh Company, Ltd., Tokyo (JP)

(21) Appl. No.: 12/034,113

(22) Filed: Feb. 20, 2008

(30) Foreign Application Priority Data
Mar. 19, 2007 (JP) 2007-070708

(51) Int. Cl. H04N 1/04

(52) U.S. Cl. 358/474

(57) ABSTRACT

In an image processor, an image transfer control unit segments a unit of a process for each image process request, and causes an image processing unit to carry out an image process on image data from reading units.

### CROSS-REFERENCE TO RELATED APPLICATIONS

The present application claims priority to and incorporates by reference the entire contents of Japanese priority document 2007-070708 filed in Japan on Mar. 19, 2007.

### BACKGROUND OF THE INVENTION

1. Field of the Invention

The present invention relates to an image processor, an image forming apparatus, an image processing method, a computer program product.

2. Description of the Related Art

Development of a reader equipped with a line sensor composed of charge-coupled device (CCD) photoelectric conversion elements and a laser-emission-based toner writing device has lead to wide spread use of a digital copier that makes a copy out of digital image data obtained by digitizing data from an analog copier. The digital copier shows high affinity for other devices handling digital image data, being capable of performing not only the copy function but also a multiple function including a facsimile function, a printer function, a scanner function, and the like. Hence the digital copier is no longer just a copier, but is now called digital multifunction product (MFP). In the meantime, technologies related to the MFP has advanced to provide memories, such as hard disk drives (HDDs), having a greater capacity and requiring less costs, faster and widespread network communication techniques, central processing units (CPUs) with improved processing capability, and new techniques related to digital image data (compression technique). This advancement in MFP technologies leads to a wide variety of functions incorporated into the MFP.

With such advancement in the technologies, use of the MFP becomes abundant in ways and types. For example, a small-sized MFP is paired with a personal computer (PC), being placed by the side of the PC to readily offer a user a function of copying, faxing, printing, and scanning. A middle-sized MFP is shared with several workers in a department or section, offering a certain advantage in productivity and combined functions of sorting, punching, stapling, and the like. In business application, a multifunctional large-sized MFP capable of higher output and product quality is used in a department concentrating on copy-related operations, or in a company specialized in copy-related businesses. Thus, the type and the way of use of the MFP are now diverse.

As MFPs vary in size to be classified into a small-sized class, a middle-sized class, and a large-sized class, some functions can be used in common in all size classes while a specific function is strongly required in a specific class. For example, a large-sized MFP has a strong requirement for a function of such a post-process on a paper following plotting as punching, stapling, and paper-folding, and of electronic filing accompanying copying, and a small-sized MFP has a strong requirement for a superior function of Internet fax, PC-fax, and the like, and of high-quality image printing on a dedicated paper in personal use. In the MFP market where the tide of diversification is going on, however, a system including a package of functions required for each size class has been built for sale and distribution.

Today, the importance of information in business activity is a well known fact, and people require not only faster, accurate, and certain transmission of information but also understandable and effective transmission. With emergence of faster and widespread communication technologies, large-capacity, low-cost, small-sized memories, and high-performance PCs, newly developed functions for efficiently processing digital-data-based information are now available. This brings a demand for incorporating new functions into the MFP that processes digital image data, which is one form of digital data. A MFP now allows setting of a number of requests on its operation unit, which brings a need of an image process control device that controls those many requests. A middleware unit (DPS: Digital Signal Processor), in compassion with a conventional hardware unit (application specified integrated circuits (ASIC)), enables various image processes through replacement of programs and data. As variations of image processes increase, however, the control device controlling the DSP for image processes is forced to handle more complicated work. Besides, easiness in a specification change leads to lots of expected specification changes, which needs to be handled in quick and certain response through image process control. In addition to the image process control device meeting various requests from the operation unit, therefore, a mechanism capable of responding flexibly to specification changes is now in demand.

Since the DSP is expensive compared to the ASIC, the ASIC is put in charge for an image process that accompanies less changes. In this manner, a device capable of image processing serves in selective use and in multipurpose use as well, for which a proper control device is necessary.

Image processes carried out by the MFP includes a request for bill recognition (IDU: Identifying Unit) technique and for an illegal copy detection/prevention technique of recognizing a specific copy guard pattern to specify a portion to paint out. A demand for higher security has become as important as or more important than a demand for image quality in these days, which makes it essential that an image process device in the MFP is equipped with a recognition technique.

A demand for higher productivity has lead to increasing calls for a double-side simultaneous reader. A conventional machine copies a front side and a back side of a paper by first scanning the front side in a document feeder (DF) and then reversing the paper to read the back side. This method requires the machine to reverse the paper to carry out second scanning, which hampers improvement in productivity. A double-side simultaneous reading function has been demanded to solve such a problem. The double-side simultaneous reading function is the function of causing a scanner CCD to read the front side and a contact image sensor (CIS) to read the back side at the same time during one cycle of reading operation to produce electronic data to be processed.

For example, apparatuses having the above double-side simultaneous reading function are disclosed in Japanese Patent Application Laid-Open No. 2005-012442, Japanese Patent Application Laid-Open No. 2005-025072, and Japanese Patent Application Laid-Open No. 2006-217030.

In the apparatuses disclosed in Japanese Patent Application Laid-Open No. 2005-012442, Japanese Patent Application Laid-Open No. 2005-025072, and Japanese Patent Application Laid-Open No. 2006-217030, the scanner CCD reads the front side and the contact image sensor reads the back side during one cycle of reading operation, and digitized electronic data read by the CCD and CIS are processed all together by an image processing device. This requires a configuration as shown in FIG. 23, in which an image processing unit (IPU) 104 includes an image processing device 105 for a scanner CCD 101, an image processing device 105 for a contact image sensor 102, and an image processing device 105 for a printer 103. Therefore, the number of the image processing devices 105 is increased, posing a problem in the aspects of process efficiency and cost.

### SUMMARY OF THE INVENTION

It is an object of the present invention to at least partially solve the problems in the conventional technology.

According to an aspect of the present invention, there is provided an image processor including a plurality of reading units that individually reads an image and acquire image data; an image processing unit that carries out a given image process on image data acquired by each of the reading units; and a storing unit that temporarily stores therein the image data; an image transfer control unit that controls transfer of the image data among the reading units, the image processing unit, and the storing unit, wherein the image transfer control unit segments a unit of a process for each image process request, and causes the image processing unit to carry out an image process on the image data from the reading units.

According to another aspect of the present invention, there is provided an image processing method that is implemented on an image forming apparatus that includes a plurality of reading units, an image processing unit that carries out a given image process on image data acquired by each of the reading units, and a storing unit that temporarily stores therein the image data, and that causes the image processing unit to carry out an desired image process, the image processing method including segmenting a unit of a process for each image process request; controlling image transfer timing; and causing the image processing unit to process the image data from the reading units.

According to still another aspect of the present invention, there is provided a computer program product including a computer usable medium having computer readable program codes embodied in the medium that, when executed, causes a computer to execute: segmenting a unit of a process for each image process request; controlling image transfer timing; causing an image processing unit to process an image data from reading units; setting a parameter for a front side image of the image data input from the reading units on an illegal copy determining unit before processing of the front side image; setting a parameter for a back side image of the image data on the illegal copy determining unit before processing of the back side image; and causing the illegal copy determining unit to determine on whether the image data is illegal copy.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a principle configuration of an image processor according to an embodiment of the present invention;

FIG. 2 is a block diagram of a configuration of an image processor of a first example;

FIG. 3 is a block diagram illustrating a flow of image data in an image processing unit of the first example;

FIG. 4 is a table representing a relation between application programs to be used and image data paths used for the application programs;

FIG. 5 is a schematic diagram representing a relation between a controller, an upper-level control device, and a double-side simultaneous reading image process control device;

FIGS. 6A and 6B are timing charts of an example of call timing for the upper-level control device and the double-side simultaneous reading image process control device;

FIGS. 7A and 7B are schematic diagrams of an example of image processing modules in a hardware unit and a middleware unit;

FIG. 8 is a flowchart of an example of a procedure executed in the double-side simultaneous reading image process control device in carrying out a calculation request;

FIG. 9 is a flowchart of an example of a procedure executed in the double-side simultaneous reading image process control device in carrying out a setting request;

FIG. 10 is a flowchart of an example of a procedure executed in the double-side simultaneous reading image process control device in carrying out an end setting request;

FIG. 11 is a block diagram of the configuration of an image processor of a second example;

FIG. 12 is a block diagram illustrating a flow of image data in an image processing unit of the second example;

FIGS. 13A and 13B are tables representing a relation between application programs and image data paths used for the application programs in a case where an option board is not attached and a case where the option board is attached;

FIGS. 14A and 14B are schematic diagrams of image processing modules in a hardware unit and two middleware units;

FIG. 15 is a flowchart of an example of a procedure executed in a double-side simultaneous reading image process control device in carrying out a calculation request in the second example;

FIG. 16 is a flowchart of an example of a procedure executed in the double-side simultaneous reading image process control device in carrying out a setting request in the second example;

FIG. 17 is a schematic diagram of an example of output contents in calculation on a filter process in a third example;

FIG. 18 is a flowchart of a procedure of calculation on the filter process that is executed while taking a difference into account;

FIG. 19 is a flowchart of a procedure of setting on the filter process that is executed while taking a difference into account;

FIG. 20 is an example of image process parameters;

FIG. 21 is an example of parameters set in the middleware unit;

FIG. 22 is an example of parameters set in the hardware unit; and

FIG. 23 is a block diagram of an example of the configuration of an image processor of a conventional double-side simultaneous reader.

### DETAILED DESCRIPTION OF THE PREFERRED EMBODIMENTS

Exemplary embodiments of the present invention are explained below with reference to the accompanying drawings.

In the present embodiments, the reading unit is equivalent to the scanner CCD 101 and the contact image sensor 102, the image processing unit is equivalent to a hardware unit 301 and a middleware unit 302, the storing unit is equivalent to a storing unit 107, the image transfer control unit is equivalent to a double-side simultaneous reading image process control device 502, and the illegal copy determining unit is equivalent to an illegal copy detection process 1501.

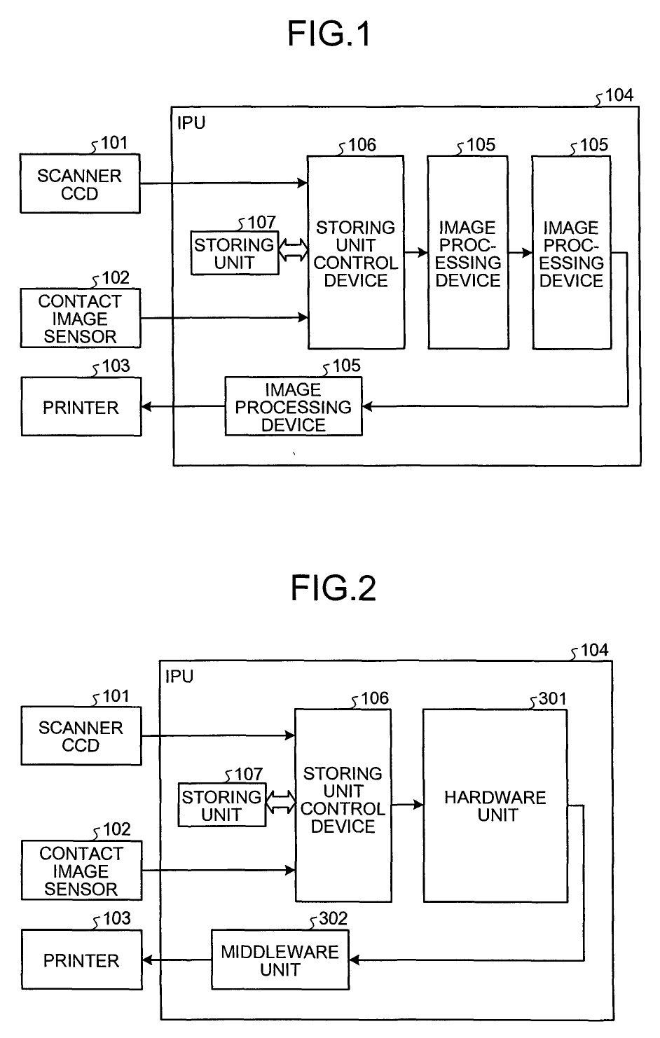

FIG. 1 is a block diagram of a principle configuration of an image processor according to the embodiment of the present invention. In the present embodiment, as shown in FIG. 1, the IPU 104 includes a storing unit control device 106, and a storing unit 107 having a capacity for saving several color images. An image input to the scanner CCD 101 and an image input to a contact image sensor 102 are stored in the storing unit 107, and are processed sequentially in shifted timing by the serially arranged image processing devices 105 and 105 to suppress costs for the image processing devices 105. For further cost reduction, the images input to the scanner CCD 101 and to the contact image sensor 102 is processed by one image processing device 105. For this operation, a control unit for the image processing devices is necessary and important to carry out high-speed changeover between setting of image process parameters for a front side and setting of image parameters for a back side.

FIG. 2 is a block diagram of the configuration of an image processor of a first example, in which three image processing devices 105 of the IPU 104 shown in FIG. 1 are replaced with a hardware unit (ASIC) 301 and a middleware unit (DSP) 302. In all examples, units to be controlled by a double-side simultaneous reading image process control device 502 is limited to the hardware unit 301 and middleware unit 302. Timing of input/output of image data to/from the image processing device 105, such as storage of an image on the storing unit control device 106 and the storing unit 107, is, therefore, managed by another image process control device incorporated in the MFP. The function of the double-side simultaneous reading image process control device 502 is to send image data to the hardware unit 301 and the middleware unit 302 and to set image process parameters before the start of an image process so that the optimum image process can be carried out in the image processing device 105.

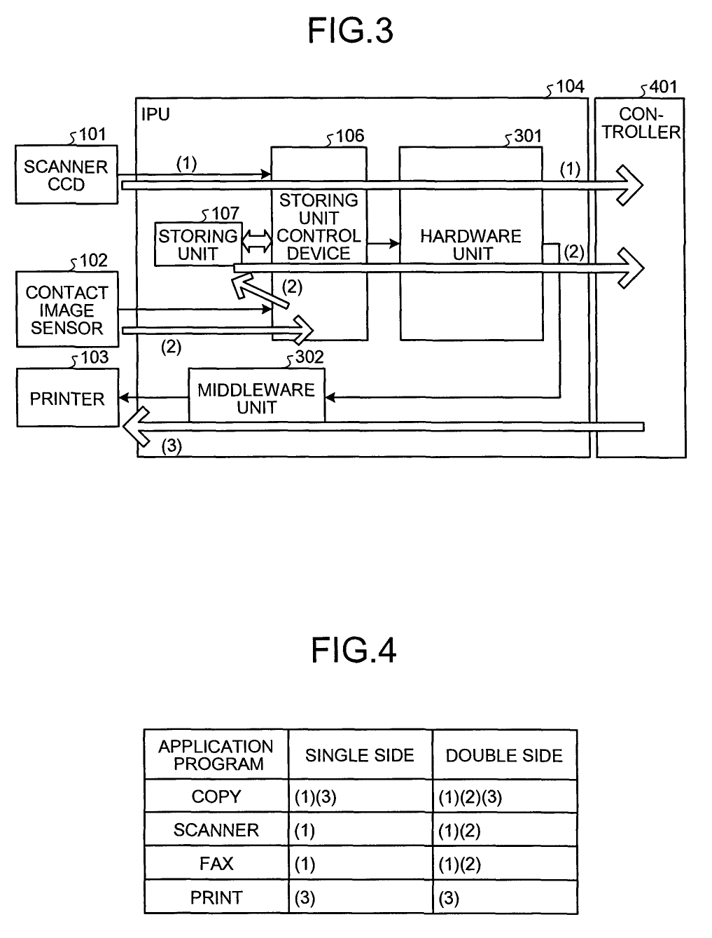

FIG. 3 is a block diagram illustrating a flow of image data in the IPU 104 of the first example. The MFP system of the first example offers four types of usable application programs including a copy application program, a scanner application program, a fax application program, and a print application program. The flow of image data resulting from each program is shown in FIG. 3. Although the type of image data varies as a result of single-side scanning by the scanner CCD 101 and double-side simultaneous scanning using both scanner CCD 101 and contact image sensor 102, the flow of image data is formed as a combination of three data flows through paths (1) to (3), as shown in FIG. 3.

FIG. 4 is a table representing a relation between application programs to be used and image data paths used by the application programs. As shown in FIG. 4, in a case of single-side printing in copying, image data sent from the scanner CCD 101 proceeds through the storing unit control device 106 to reach the hardware unit 301 serving as the image processing device 105 where the image data is subjected to a correction process on a scanner input image, and is further transferred to a controller 401. Subsequently, the controller 401 sends image data back to the IPU 104 in which the image data is subjected to a correction process on a plotter input image at the middleware unit 302 serving as the image processing device 105, and is further sent to the printer 103 to be printed out.

In a case of double-side simultaneous reading, an image data path (2) for the back side is added to the image data paths for single-side printing for copying. Because only one hardware unit 301 is provided, an image input from the scanner CCD 101 and an image input from the contact image sensor 102 cannot be processed at the same time. For this reason, the image input from the contact image sensor 102 is stored temporarily in the storing unit 107 by using the storing unit control device 106 until the hardware unit 301 completes the image process on the image input from the scanner CCD 101. Once the image process is over, the image input from the contact image sensor 102 is sent through the storing unit control device 106 to the hardware unit 301 where the image is subjected to the correction process on the scanner input image, and is further transferred to the controller 401.

Through the image process path from the controller 401 to the printer 103, the image data input from the scanner CCD 101 is sent first to the middleware unit 302 where the image data is subjected to the correction process on the plotter input image, and is further transferred to the printer 103. Subsequently, the image data input from the contact image sensor 102 is processed in the same manner through the image process path to output an image printed on both sides of the sheet. In scanning and faxing (transmission), image data flows through the image data path (1) for single-side printing in copying and image data paths (1) and (2) for double-side printing in copying. In the data flow, image data having been subjected to the image process at the hardware unit 301 is sent to the controller 401, from which the image data is transmitted to a client PC or a printer connected to the image processor via a network, such as local area network (LAN). In printing and faxing (reception), through the image data path (3), image data for single-side printing as well as that for double-side printing are sent from the controller 401 to the middleware unit 302 where the image data is subjected to the correction process on the plotter input image, and is further transferred to the printer 103 to be printed out.

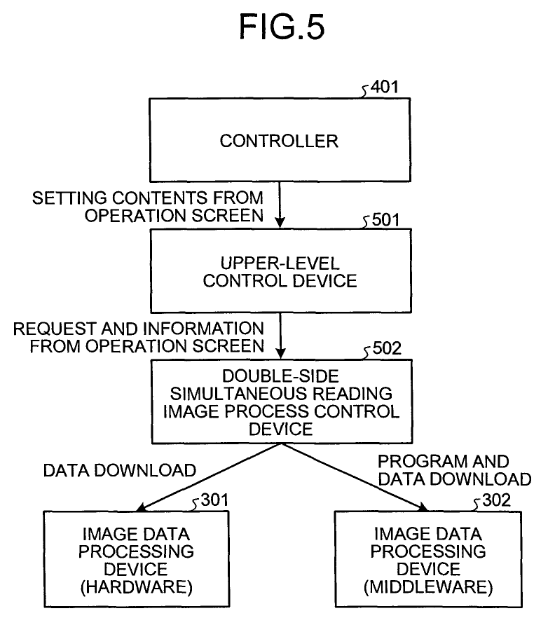

FIG. 5 is a schematic diagram representing a relation between the controller 401, an upper-level control device 501, and a double-side simultaneous reading image process control device 502.

The double-side simultaneous reading image process control device 502 of the present example receives user-specified information from an operation screen on the controller 401 via the upper-level control device 501. Receiving the user-specified information (setting on a manuscript mode, magnification rate, thickness, and the like) sent from the upper-level control device 501, the image process control device 502 downloads a program and data onto the hardware unit 301 and the middleware unit 302, which are the image processing devices put under control by the image process control device 502, and controls setting of image process parameters to output an image optimum to the user. The upper-level control device 501 sends out the user information set on the operation screen, and controls reading timing for the double-side simultaneous reading image process control device 502 to set up a process. The double-side simultaneous reading image process control device 502 changes the process according to a called request with the reading of the process as a trigger.

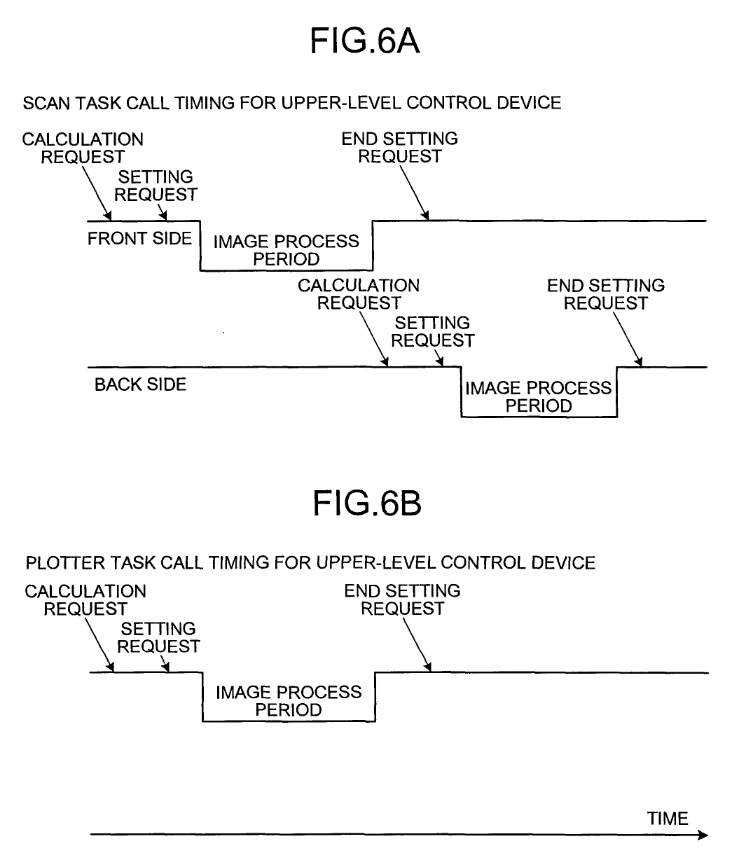

FIGS. 6A and 6B are timing charts of an example of call timing for the upper-level control device 501 and the double-side simultaneous reading image process control device 502. FIG. 6A is a timing chart of an example of call timing for the upper-level control device 501 to call a task of the scanner CCD 101. FIG. 6B is a timing chart of an example of call timing for the upper-level control device 501 to call a task of the printer 103.

In FIGS. 6A and 6B, the upper-level control device 501 is divided functionally for each task, and the double-side simultaneous reading image process control device 502 carries out setting on image processes necessary for scanner input and plotter input. As a result, the process from which a request for setting is originated is either of two processes of a scan process and a plotter process. Because different image processing devices 105 carry out different processes for scanner data and plotter data in the IPU configuration of the MFP in the present embodiment, request timing may overlap as shown in FIGS. 6A and 6B. The double-side simultaneous reading image process control device 502 manages a unit of one image process as one process, in which control operation is completed through execution of a calculation request, a setting request, and an end setting request.

In the calculation request, image process parameters are calculated to maintain the image process parameters to be set on the image processing device 105. In the setting request, the contents of image process parameters calculated and stored in advance are set on the image processing device 105. In the end setting request, a post-process is carried out to prevent such a memory leak as releasing of the stored result of the calculation.

In the scan process, for a request for setting on the front side only, the calculation request and setting request are sent out before the start of an image process by the image processing device 105 to put the image processing device 105 ready for execution of the image process, and image data is sent to the image processing device 105 to cause it to execute the image process, and then the end setting request is sent out to cause the double-side simultaneous reading image process control device 502 to complete control over one process. For setting on both sides, additional requests for the back side are sent to the double-side simultaneous reading image process control device 502 as in the same manner in the case of the front side to cause the image process control device 502 to control one process. Process control for the plotter task is basically the same as that for the scan task, but the image processing device 105 for parameter setting is different from a device actually executing the image process.

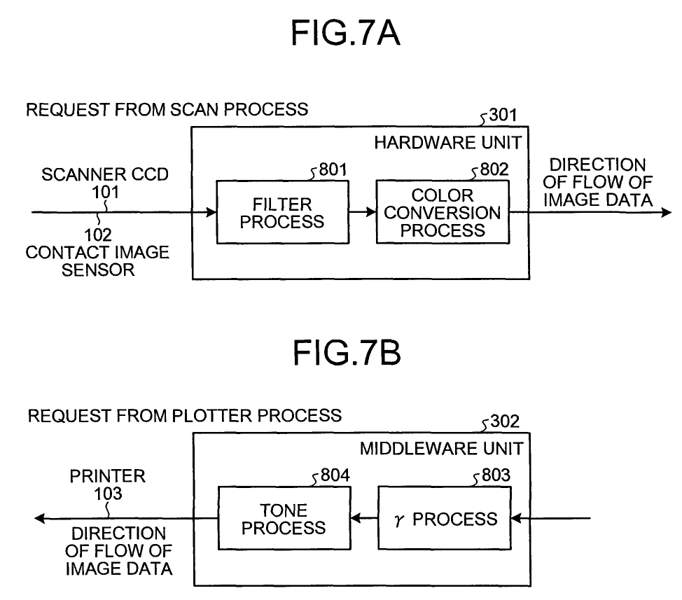

FIGS. 7A and 7B are schematic diagrams of an example of image processing modules in the hardware unit 301 and the middleware unit 302, representing the image process contents (process function) in the hardware unit 301 and the middleware unit 302 that serve as the image processing devices 105 incorporated in the IPU 104 of the MFP system of the present example. The hardware unit 301 includes processing units (modules) of a filter process 801 and a color conversion process 802 to correct image data input from the scanner CCD 101 and the contact image sensor 102. The filter process 801 is the processing module that emphasizes edges of an image, smoothes the image to reduce noises, or makes modulation transfer function (MTF) characteristics closer to the image data input from the scanner CCD 101 and the contact image sensor 102. The color conversion process 802 converts color signals of RGB input image data to output CMYK color image data. The middleware unit 302 carries out an image process for the printer 103, causing modules of a γ process 803 and a tone process 804 adjusted to printer characteristics to carry out tone conversion due to the difference in the number of tones required for input and output. In the present example, these four image processing modules are put under control by the double-side simultaneous reading image process control device 502.

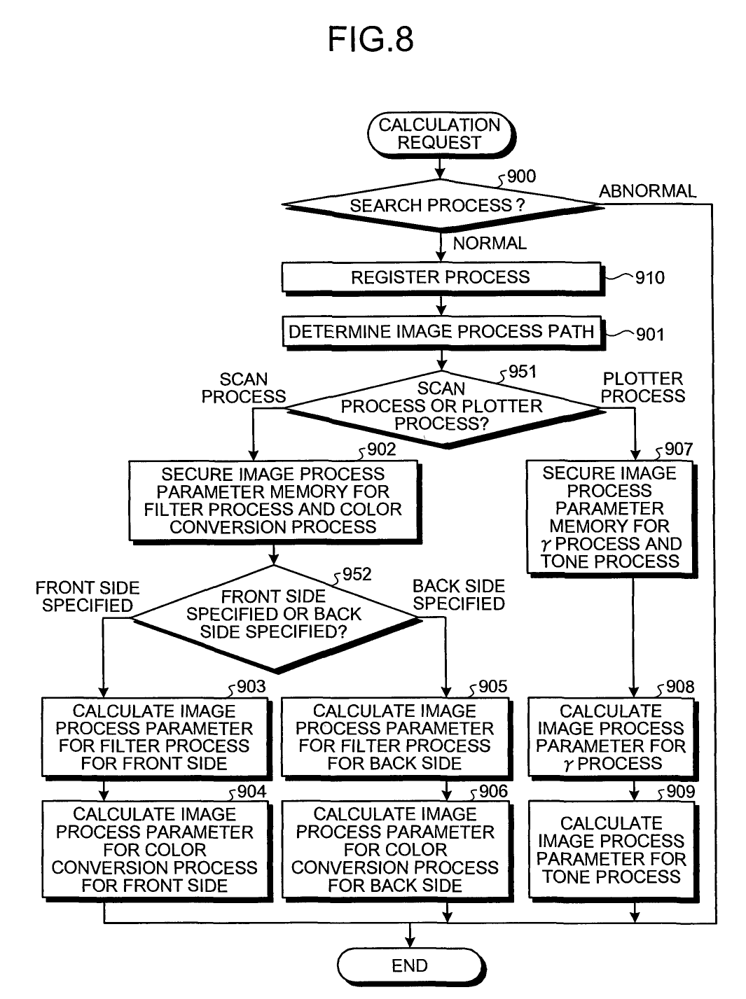

FIG. 8 is a flowchart of an example of a procedure executed in the double-side simultaneous reading image process control device 502 in carrying out a calculation request, representing the contents of a process carries out by the double-side simultaneous reading image process control device 502 in response to a calculation request from the upper-level control device 501. In FIG. 8, the double-side simultaneous reading image process control device 502 first responds to requests from a plurality of scan processes and plotter processes. Because the scan process and the plotter process are handled as different tasks, such a case may happen that task switching occurs while the scan process is processed to change from processing of the scan process to that of the plotter process, and to that of the scan process again. To manage these scan processes and plotter processes, the double-side simultaneous reading image process control device 502 independently carries out management of process information for the scan process and that for the plotter process. In process searching, process information already called and registered by the double-side simultaneous reading image process control device 502 is searched (step 900). The search contents include the type of a process, i.e., whether the process is the scan process or the plotter process, and the process number of each process. When a calculation request is called again referring to the already registered type and number of the same process, the call is regarded as an abnormal call, which leads to the end of the process without calculation. When process information is searched to find out a call is not abnormal, the type and process number of the process, which is the process information, is registered (step 910).

While the double-side simultaneous reading image process control device 502 controls four modules, modules necessary for the scan process and that necessary for the plotter process are predetermined. At image path determining step (step 901), therefore, the image process control device 502 determines on whether a request is from the scan process or from the plotter process (step 951), and specifies modules necessary for the image process to carry out calculation on the minimum necessary modules.

When a request is from the scan process, image process parameters for the filter process 801 and the color conversion process 802 need to be calculated. An image process parameter memory for the filter process and for the color conversion process, therefore, is secured as a memory for storing a result of the calculation therein (step 902). In the scan process, separate image process parameters are set for input from the scanner CCD 101 for the front side and for input from the contact image sensor 102 for the back side. For this reason, whether the front side is specified or the back side is specified is determined (step 952). Depending on the result of the determination, a determination is made on whether to execute image process parameter calculation for the filter process for the front side (step 903) or image process parameter calculation for the filter process for the back side (step 905), and on whether to execute image process parameter calculation for the color change process for the front side (step 904) or image process parameter calculation for the color change process for the back side (step 906). Following the execution of a determined calculation, a result of the calculation is stored in the memory that is secured (at step 902) as the image process parameter memory for the filter process 801 or for the color conversion process 802, and the calculation process ends.

When a request is from the plotter task, a difference in characteristics between image data for the front side and that for the back side has been corrected through the image process in the scan task, so that no process change is necessary in the image process at the plotter task side. Besides, the modules necessary for the calculation process are predetermined to be the γ process 803 and the tone process 804. Because of this, an image process parameter memory for the γ process and tone process is secured (step 907) to secure parameters for the γ process and tone process that are the minimum necessary modules. Then, image process parameter calculation is carried out as image process parameter calculation for the γ process (step 908) and image process parameter calculation for the tone process (step 909), and a result of the calculation is stored in the secured memory to end the calculation process.

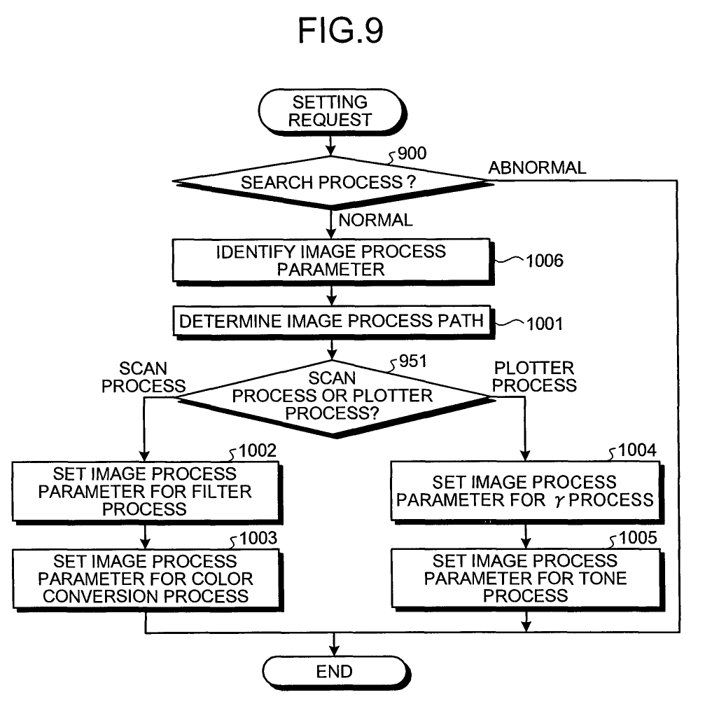

FIG. 9 is a flowchart of an example of a procedure executed in the double-side simultaneous reading image process control device 502 in carrying out a setting request. In the setting process, access is made to the image processing device 105 to set image process parameters, which have been calculated by the calculation process, on the image processing device 105. Because of this, setting parameters during an image process hampers normal execution of the image process to create an abnormal image, so that it is not preferable that the setting process be executed during the image process. For this reason, parameter setting is made only on the image processing device 105 having an image processing module necessary for a requested process. A control procedure of the setting request is basically the same as the procedure of the calculation request. Therefore, process search, which is under management by the double-side simultaneous reading image process control device 502, is carried out (step 900) to check whether the type and number of a process making the setting request is present. If the process type and number are not present, it means that setting request is called before a call for calculation, so that the setting process is ended without performing any process. When the process type and number are present, image process parameters to set are identified based on in which process the parameters are calculated by using the checked process information (step 1006).

Then, the process making the request is identified, and an image process path is determined (step 1001), which is followed by path setting according to the determined image process path (step 951). When the request is from the scan process, based on image process parameter information stored in the secured memory as the result of the calculation, the filter process 801 and the color conversion process 802 carry out the setting process according to stored information contents regardless of a difference between setting for the front side and that for the back side at steps of image process parameter setting for filter process 1002 and image process parameter setting for color conversion process 1003 (steps 1002 and 1003). When the request is from the plotter process, based on image process parameter information stored in the secured memory as the result of the calculation, the γ process 803 and the tone process 804 carry out the setting process according to stored information contents at steps of image process parameter setting for γ process 1004 and image process parameter setting for tone process 1005.

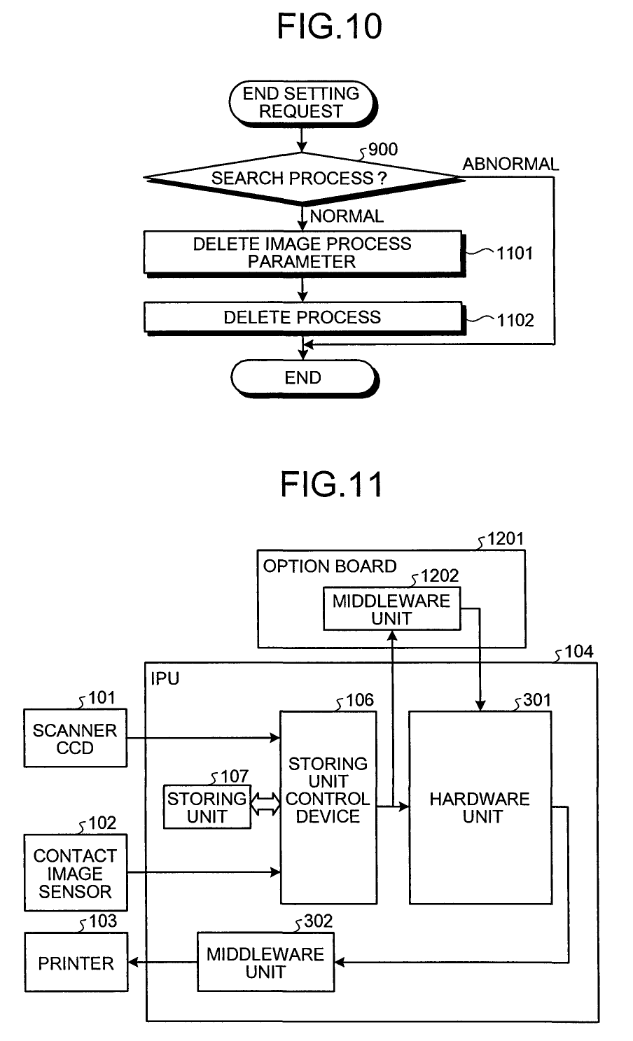

FIG. 10 is a flowchart of an example of a procedure executed in the double-side simultaneous reading image process control device 502 in carrying out an end setting request.

The end setting is executed to release process information, which is registered for a calculation request and is under management by the double-side simultaneous reading image process control device 502, and the memory secured in the process for saving image process parameters. First, process search is carried out (step 900) to determine on whether the end setting request is from the scan process or the plotter process. Because both processes are managed independent of each other, a management place to refer to is identified, at which it is checked whether the type and number of a process making the request is present. When the type and number are not present, it means that the end setting request is called before a call for a calculation request, so that the end setting is ended without performing any processing. When the type and number are present, image process parameters to delete are identified based on in which process the parameters are calculated, by using the checked process information, and the parameters are deleted (step 1101) to release the memory for the parameters. Following the end of processing the identified process information, the process identified by the process information is deleted at step 1102 (step 1102) to end the end setting process.

FIG. 11 is a block diagram of the configuration of an image processor of a second example, in which an option board 1201 is connected to the IPU 104 of the image processor of the second example. In the present example, the removable illegal copy preventive option board 1201 is connected to the IPU 104 incorporated in the MFP system of the present embodiment. The IPU 104 of FIG. 11 has the same configuration as that in the first example, so that the explanation thereof is omitted.

In the present example, the removable illegal copy preventive option board 1201 is connected to the IPU 104 of the first example, and the option board 1201 includes an additional middleware unit 1202 that detects illegal copy on the image processing device 105.

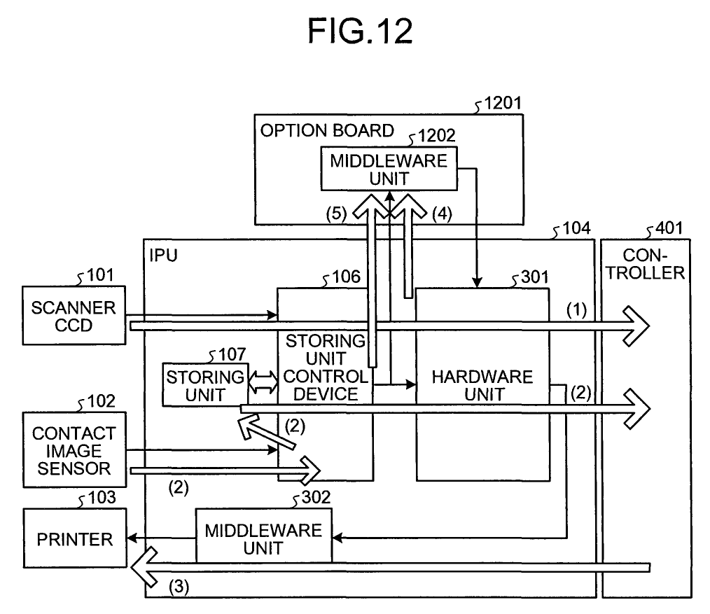

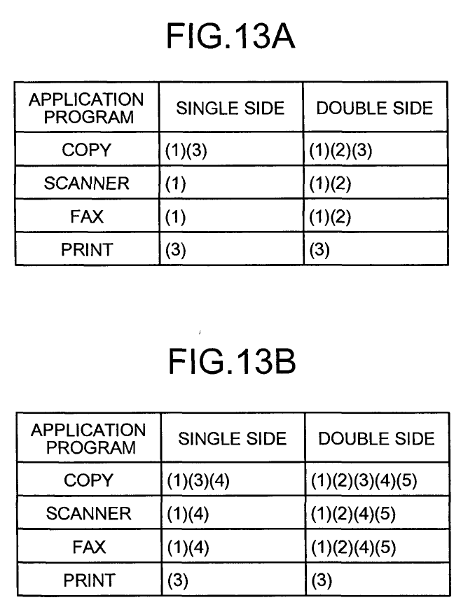

FIG. 12 is a block diagram illustrating a flow of image data in the IPU 104 of the second example, and FIGS. 13A and 13B are tables representing a relation between application programs and image data paths used for the application programs in a case where the option board 1201 is not attached and a case where the option board 1201 is attached.

Referring to FIG. 12, image data read at the scanner CCD 101 or at the contact image sensor 102 is sent from the storing unit control device 106 to the hardware unit 301, at which time the same image data is sent also to the middleware unit 1202 of the option board 1201. As a result, an image data path (4) is added at the time of input from the scanner CCD 101, and an image data path (5) is added at the time of input from the contact image sensor 102. When the middleware unit 1202 finds the image data to be illegal copy, the middleware unit 1202, which is physically connected to the hardware unit 301 of the IPU 104, automatically changes the setting contents to setting for painting out the image data to make it unreadable. The image is thus painted out, and is sent to the controller 401. When the middleware unit 1202 finds the image data to be not illegal copy, the middleware unit 1202 does not carry out any process on the hardware unit 301, and the original image data is sent to the controller 401. The paths shown in FIG. 13A for a case of no connection of the illegal copy preventive option board 1201 are the same as the paths shown in FIG. 4.

In a case of double-side simultaneous reading, illegal copies of image data input from the scanner CCD 101 and from the contact image sensor 102 are detected by one middleware unit 1202. In the same manner as the data flow in the hardware unit 301 for double-side simultaneous reading, the image data from the scanner CCD 101 is sent first, while the image data from the contact image sensor 102 is stored in the storing unit 107 by using the storing unit control device 106. When the hardware unit 301 completes the image process, including the process by the middleware unit 1202, on the image data from the scanner CCD 101, the image data finished with the image process is sent to the controller 401. Following this, the image data from the contact image sensor 102 is taken out of the storing unit 107 to be sent to the middleware unit 1202 and to the hardware unit 301 where the image data is subjected to the image process, and is sent to the controller 401.

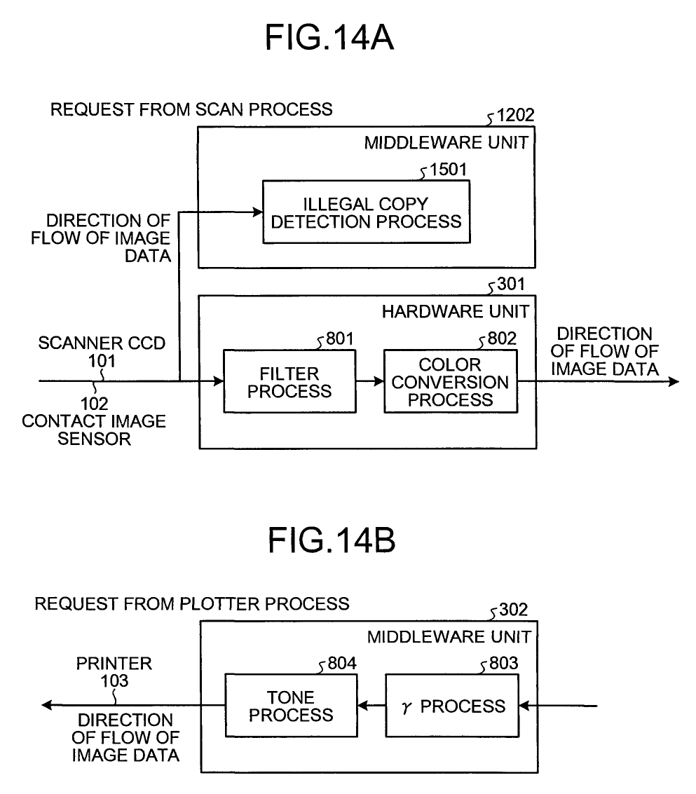

FIGS. 14A and 14B are schematic diagrams of an example of image processing modules in the hardware unit 301, the middleware unit 302, and the middleware unit 1202. In FIGS. 14A and 14B, the middleware unit 1202 is added to the configuration of FIGS. 7A and 7B of the first example. As described above, this middleware unit 1202 represents the image processing device 105 incorporated in the option board 1201, executing an illegal copy detection at an illegal copy detection process 1501. The illegal copy detection process 1501 is the module that is needed to be controlled to carry out the illegal copy detection process on an image input from the scanner CCD 101 or from the contact image sensor 102 when the scan process is executed. When illegal copy is detected by the illegal copy detection process 1501, the setting is changed automatically at the hardware unit 301 to setting for painting out image to make it unreadable.

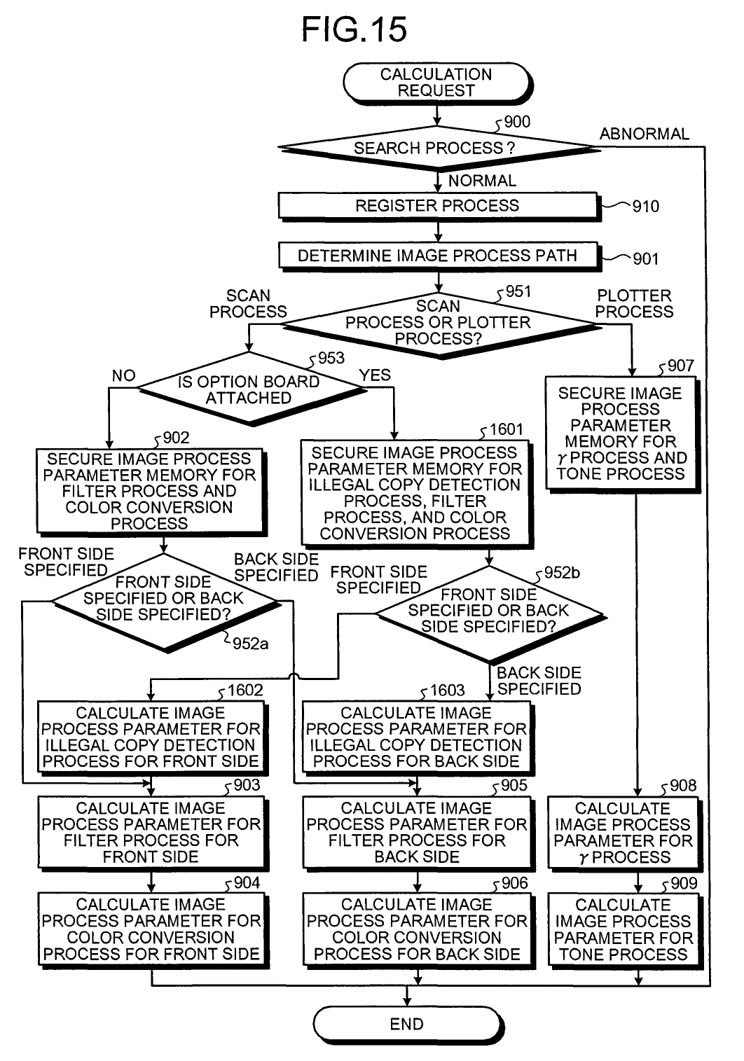

FIG. 15 is a flowchart of an example of a procedure executed by the double-side simultaneous reading image process control device 502 in carrying out a calculation request in the second example. The procedure of FIG. 15 is basically the same as that of FIG. 8, but is partly different in steps following the scan process. In other words, in the procedure of FIG. 15, the procedure of the FIG. 8 is changed at step of the scan process, at which the following steps branch into a case of connection of the option board 1201 and a case of nonconnection of the option board 1201. When the option board 1201 is connected, a memory securing process 1601 including securing of a memory necessary for calculation for the illegal copy detection process 1501 is carried out. When the option board 1201 is not connected, the procedure same as that of FIG. 8 follows.

When the option board 1201 is connected, whether the front side is specified or the back side is specified is determined (step 1601), and image process parameter calculation for illegal copy detection process for the front side 1602 or image process parameter calculation for illegal copy detection process for the back side 1603 is executed. The process at the filter process 801 and the color conversion process 802 is executed without fail regardless of the state of the option board. In the procedure of FIG. 15, step 952a corresponds to step 952 of FIG. 8, and the rest of steps are the same as those of the procedure of FIG. 8 except step 953, step 1601, and step 952b, so that explanation of the overlapping steps is omitted.

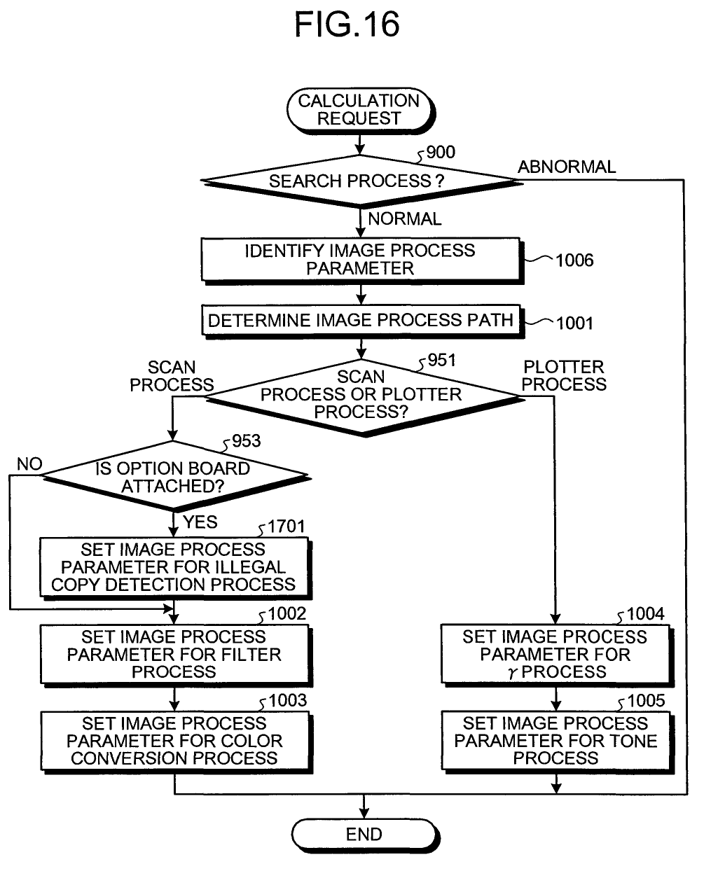

FIG. 16 is a flowchart of an example of a procedure executed by the double-side simultaneous reading image process control device 502 in carrying out a setting request in the second example. The procedure of FIG. 16 is basically the same as that of FIG. 9, but is partly different in steps following the scan process. In other words, in the procedure of FIG. 15, the procedure of the FIG. 9 is changed at step of the scan process, at which the following steps branch into a case of connection of the option board 1201 and a case of nonconnection of the option board 1201. When the option board 1201 is connected (step 953), image process parameter setting for illegal copy detection process is carried out for calculation for the illegal copy detection process 1501 (step 1701). When the option board 1201 is not connected, the procedure same as that of FIG. 9 follows. After the reception of the setting request, image data is sent to the hardware unit 301 and the middleware unit 1202, where the image process is carried out.

When illegal copy is detected during the image process at the middleware unit 1202 having the illegal copy detection process 1501, the upper-level control device 501 detects an interruption signal to rewrite a register value set by image process parameters of the color conversion process 802 in the hardware unit 301, the image process parameters being under control by the double-side simultaneous reading image process control device 502. Rewriting the register value results in sending of an unrecognizable image to the controller 401. In double-side simultaneous reading, the illegal copy detection and painting out based on a result relevant to detection are carried out on an image input from the scanner CCD 101, and the same process on the image input from the scanner CCD 101 is carried out also on an image input from the contact image sensor 102. As a result, an image having a side painted out to be unreadable as illegal copy can be output.

The procedure for carrying out an end setting request in the second example is the same as that in the flowchart of FIG. 10 representing the procedure in the double-side simultaneous reading image process control device 502 in carrying out an end setting request, so that explanation thereof is omitted.

Third example is a case where, especially in double-side simultaneous reading, a process time is reduced in the scan process for the back side after execution of a calculation request, setting request, and end setting request in the scan process for the front side by using a result of the calculation in the calculation request and setting on the hardware unit 301 and the middleware unit 1202 in the setting request in the scan process for the front side.

In double-side simultaneous reading in the MFP system in the embodiment, requests from the scan process for the front side are made first, which is followed by requests from the scan process for the back side, and the same image processing device 105 is used for both front side and back side in the scan process. Parallel calling of the scan process for the front side and that for the back side, therefore, do not happen. That means the calculation request in the scan process for the back side is carried out after the end setting request in the scan process is over. This is the precondition for the third example.

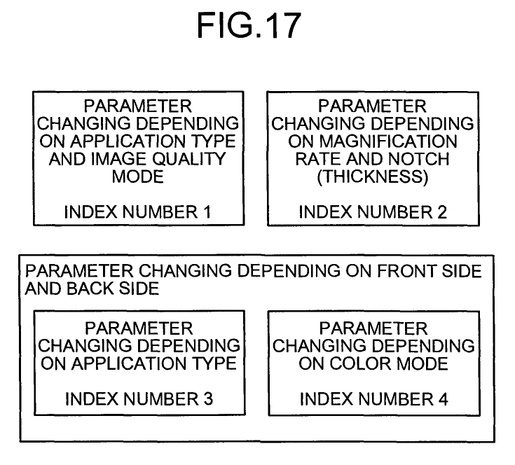

FIG. 17 is a schematic diagram of an example of output contents in calculation on the filter process in the third example. The double-side simultaneous reading image process control device 502 carries out control in segmented units of control over each image processing module. The unit of control is equivalent to one of units of management in the filter process 801 module under control by the image process control device 502. Other image process modules are also controlled in the same way as the filter process 801, under which control index numbers classified by control factors are used. In FIG. 17, index numbers 1 to 4 are appended to the units of control. The example shown in FIG. 17 indicates that the filter process 801 needs to change image process parameters depending on control elements of application type, image quality mode, magnification rate, notch, color mode, and front side/back side specification. An index number 1 is set for application type and image mode, an index number 2 is set for magnification rate and notch, an index number 3 is set for application type as an example of a parameter changing depending on front side/back side specification, and an index number 4 is set for color mode. These index numbers represent units of process related to the portion that calculates image process parameters of the filter process 801 and to the portion that sets the setting of the filter process 801 on the hardware unit 301.

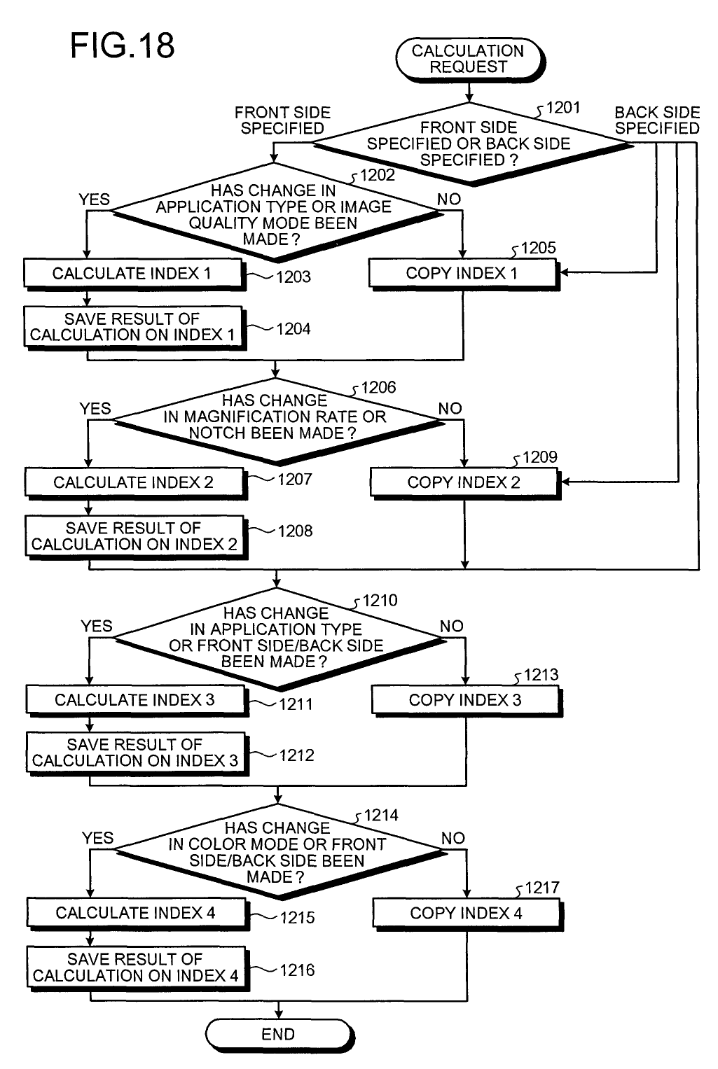

FIG. 18 is a flowchart of a procedure of calculation on the filter process that is executed while taking a difference into account. The portion calculating image process parameters of the filter process 801 stores the result of the previous calculation, comparing control elements for each process segment. When a result of the comparison shows no difference, the result of the calculation stored inside is set directly as an index number to dispense with a calculation process. When the result of the comparison shows any difference, the result of the previous calculation brings a difference in parameters, so that parameters are calculated again to save the latest calculation result, at which the result of the previous calculation stored by the part calculating image process parameters is updated.

First, whether the front side is specified or the back side is specified is checked (step 1201). When the front side is specified, whether a change in application type or image quality mode type has been made is checked (step 1202). When the change has been made, the index number 1 is calculated (step 1203), a calculation result is saved (step 1204), and then whether a change in magnification rate or notch has been made is checked (step 1206). When no change in application type has been made at step 1202, the index number 1 is copied (updated) to proceed to a determination at step 1206.

When the change in magnification rate or notch has been made at step 1206, the index number 2 is calculated (step 1207), and a result of the calculation is saved (step 1208), and then whether a change in application type or front side/back side has been made is checked (step 1210). When no change in both in magnification rate and notch has been made at step 1206, the index number 2 is copied (step 1209) to proceed to a determination at step 1210.

When the change in application type or front side/back side has been made at step 1210, the index number 3 is calculated (step 1211), a result of the calculation is saved (step 1212), and then whether a change in color mode or front side/back side has been made is checked (step 1214). When no change in both application type and front side/back side has been made at step 1210, the index number 3 is copied (step 1213) to proceed to a determination at step 1214.

When the change in color mode or front side/back side has been made at step 1214, the index number 4 is calculated (step 1215), and a result of the calculation is saved (step 1216). When no change in both color mode and front side/back side has been made at step 1214, the index number 4 is copied (step 1217) to proceed to end the procedure.

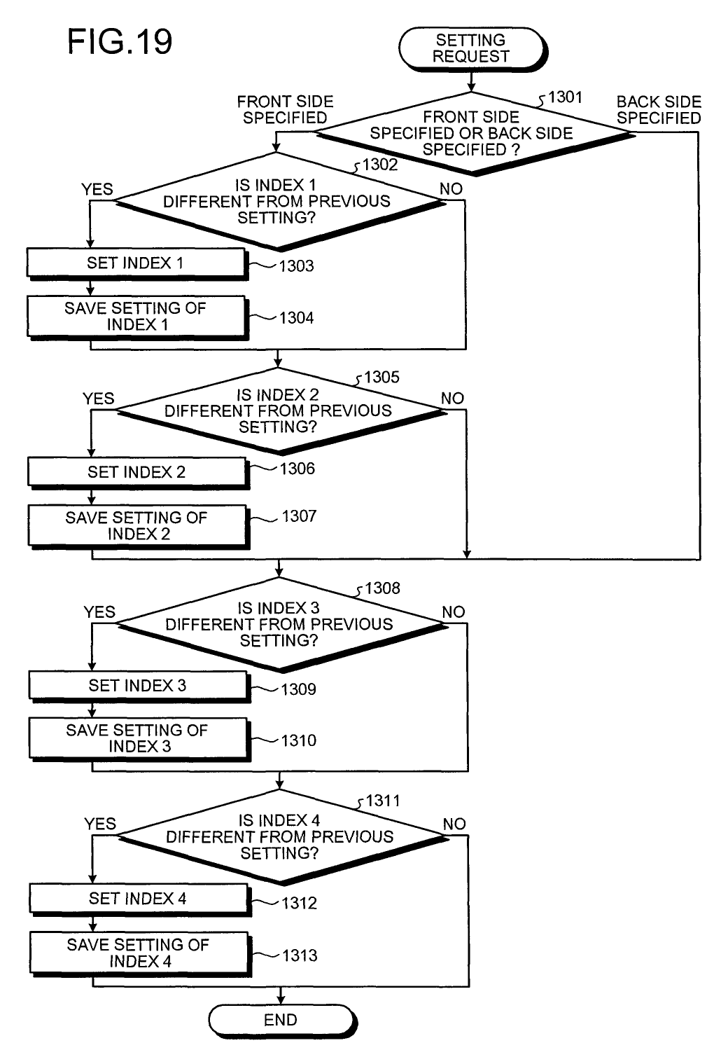

FIG. 19 is a flowchart of a procedure of setting on the filter process that is executed while taking a difference into account. The portion setting the setting of the filter process 801 on the hardware unit 301 stores the result of the previous setting in the same manner as the portion calculating image process parameters of the filter process 801, and compares the index numbers of image process parameters (P1, etc., expressing “Parameter”) for each process segment. The same index number given as a comparison result makes resetting on the hardware unit 301 unnecessary, so that a setting process is dispensed with. When the current index number is different from the previously set index number, a specific setting value is determined from the current index number to set the specific value on the hardware unit 301, which is then saved as the result of the previous setting.

For each process segment, setting on the filter process is managed in further detailed segments where a process change is necessary for the front side and back side. In the calculation request and setting request for the back side, because of the above precondition, the same result of the calculation and setting is given with regard to setting for control elements causing no difference between the front side and the back side, so that the process in this procedure is dispensed with. The subject of the process is calculation of the index numbers 3 and 4, where control elements change for the front side and for the back side.

First, whether the front side is specified or the back side is specified is checked (step 1301). When the front side is specified, the setting of the index number 1 is check (step 1302). When the setting of the index number 1 is different from the previous setting, the index number 1 is set (step 1303). The setting of the index number 1 is stored (step 1304), and the index number 2 is checked (step 1305). When the index number 1 shows no difference from the previous setting at step 1302, the index number 2 is checked at step 1305 without setting the index number 1.

When the index number 2 shows a difference from the previous setting at step 1305, the index number 2 is set (step 1306). The setting of the index number 2 is stored (step 1307), and the index number 3 is checked (step 1308). When the index number 2 shows no difference from the previous setting at step 1305, the index number 3 is checked at step 1308 without setting the index number 2.

When the index number 3 shows a difference from the previous setting at step 1308, the index number 3 is set (step 1309). The setting of the index number 3 is stored (step 1310), and the index number 4 is checked (step 1311). When the index number 3 shows no difference from the previous setting at step 1308, the index number 4 is checked at step 1311 without setting the index number 3.

When the index number 4 shows a difference from the previous setting at step 1311, the index number 4 is set (step 1312). The setting of the index number 4 is stored (step 1313), and the procedure ends. When the index number 4 shows no difference from the previous setting at step 1311, the end of the procedure follows.

When the back side is specified at step 1301, steps 1302 to 1307 are skipped to execute steps starting from the determination process at step 1308.

In the color correction process and the illegal copy detection process, a difference between setting for the front side and setting for the back side results only in the form of different parameters for color matching and different setting of a binarization threshold for simply binarizing an image before detection of illegal copy. In the calculation request and setting request in the back side scan process following the front side scan process, therefore, comparison is made only on calculation and setting of the parameters and threshold to carry out resetting.

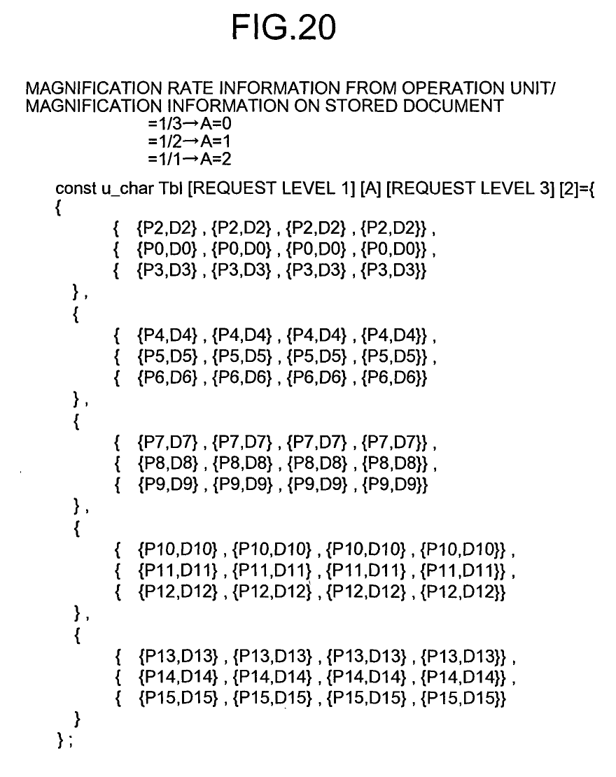

FIG. 20 is an example of image process parameters used in the present example, in which index numbers P (program number) and D (data number) are determined from a request level 1, a magnification rate, and a request level 2. The request level means application type, image quality mode, and the like that are segmented for each control factor through the user specification from the operation screen, as shown in FIG. 17.

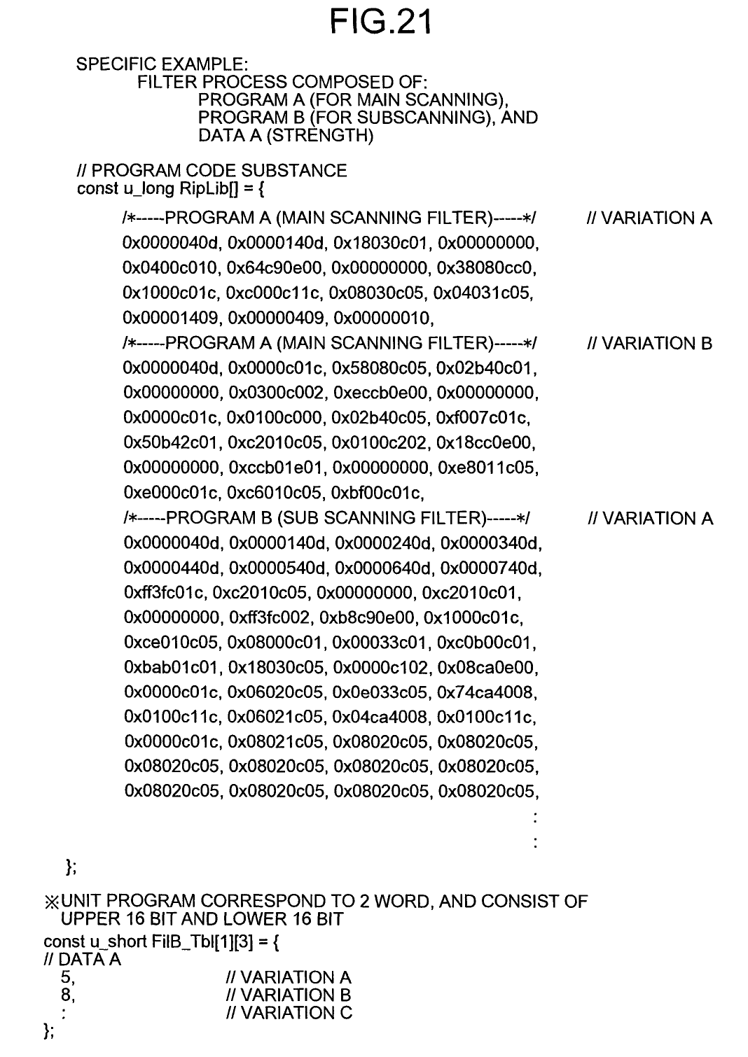

FIG. 21 is an example of parameters set in the middleware unit 302. Parameters set in the middleware unit 302 are basically the same as those set in the hardware unit 301, but are different in the point that the parameters in the middleware unit 302 are used also in handling an image process program. The parameters set in the middleware unit 302 include program parameters and data parameters. Program parameters are actually downloaded onto the middleware unit 302, where the image process is executed based on the program parameters. The program parameters are managed in the form of an arrangement consisting of hexadecimal digits. Data parameters offer values to which the program parameters downloaded on the middleware unit 302 refer to carry out the image process. Data parameters are provided as threshold process data, γ data, or the like. The program parameters and data parameters are given as digits of elements and arrangement elements on the table (const field). Parameters are written in on the table in 8 bits or 16 bits.

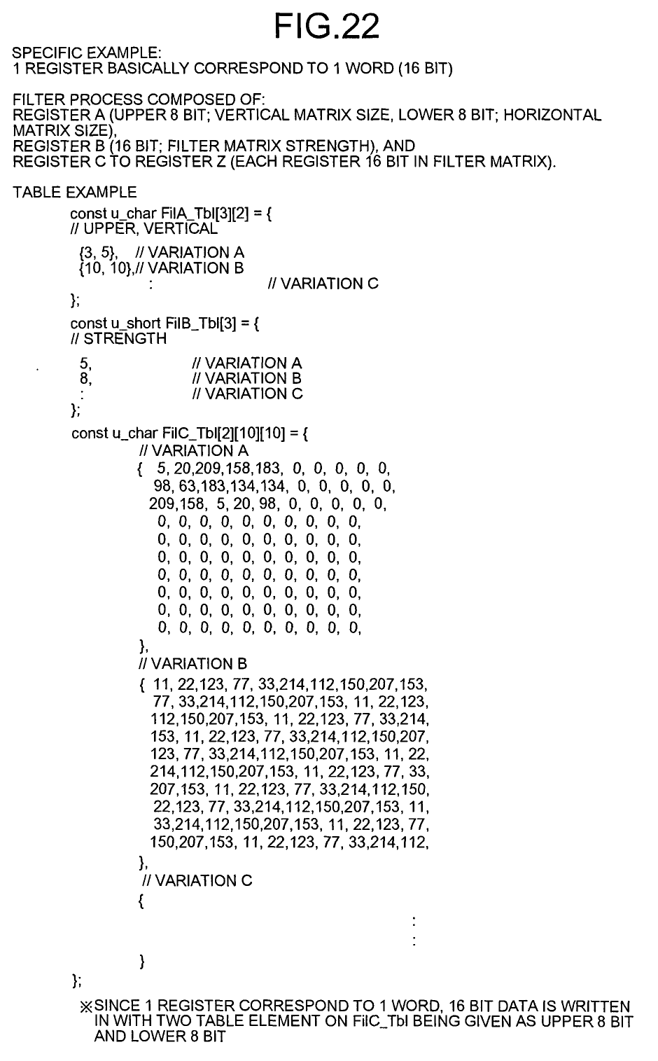

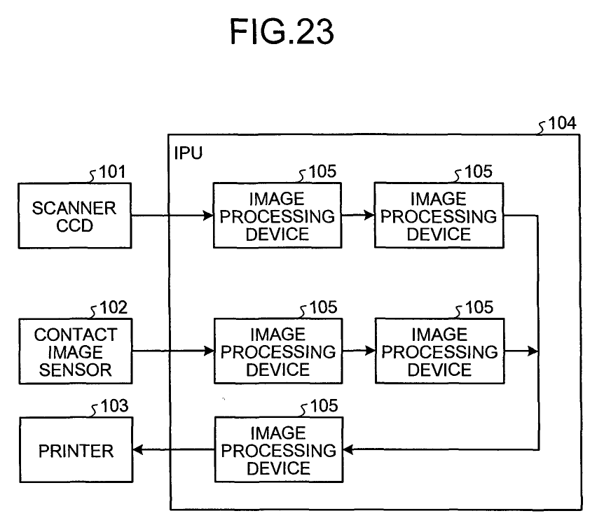

FIG. 22 is an example of parameters set in the hardware unit 301. For a group of registers already present in the hardware unit 301, table elements (image process parameters) are set according to contents assigned to each bit, by using tables (const field) having the same data capacity. A simplified example of actually set parameters is exhibited in FIG. 22, where parameters set in the hardware unit 301 are represented by 8 bit digits or 16 bit digits composing the elements of the table referred to as data.

Examples shown in FIGS. 21 and 22 correspond to the index numbers P (program number) and D (data number) shown in FIG. 20. When a setting subject is the middleware unit 302, a set value stored in the ROM using P numbers and D numbers is set in the middleware unit 302 according to index numbers selected by the portion calculating image process parameters, at which program parameters are provided in the form of hexadecimal arrangement data. When a setting subject is the hardware unit 301, a set value stored in the ROM using D numbers is set in the hardware unit 301.

As described above, the present embodiments offer the following effects.
(1) Control subject modules are not set all together, but are put under control with the minimum necessary setting through changing the setting of image process paths. This achieves improved efficiency in software processing and higher productivity.
(2) Two types of image processing devices for the scanner CCD and the contact image sensor need not be incorporated in the IPU. This keeps costs at low level.
(3) Two types of illegal copy detection process devices for the scanner CCD and the contact image sensor need not be incorporated in the IPU. This keeps costs at low level.
(4) Setting on one image processing device is made by calculating only the difference between setting for the scanner CCD and setting for the contact image sensor. This enables simplified processes and reduced control and setting process time, thus achieving improved efficiency in software processing and higher productivity.
(5) For images read for the scanner CCD and the contact image sensor, the color differences changing depending on reading characteristics can be minimized through control over parameters for the color conversion module.
(6) For images read for the scanner CCD and the contact image sensor, the MTF differences changing depending on reading characteristics can be minimized through control over parameters for the filter conversion module.
(7) Only one image processing device for illegal copy detection is provided to allow control for illegal copy detection without a process change for the scanner CCD and for contact image sensor. Determination of illegal copy leads to a painting out process at the image processing module following the determination. As a result, an image determined to be illegal copy is output as an unreadable image in a precise manner.
(8) Illegal copy detection precision is improved by changing an image optimum for illegal copy determination, using a digitalized threshold, for images input from the scanner CCD and the contact image sensor.
(9) In reading only by the scanner CCD and double-side simultaneous reading by the scanner CCD and contact image sensor, the data flow can be controlled through the same image process paths. This simplifies software processing.

According to one aspect of the present invention, a unit of a process is segmented for each image process request and image data from two or more reading units are processed by a common image processing unit. This enables image processing carried out under the minimum necessary setting, achieving improved efficiency in software processing, high productivity, and lower costs.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processor comprising:
a plurality of reading units that individually reads an image and acquire image data;
an image processing unit that carries out a given image process on image data acquired by each of the reading units; and
a storing unit that temporarily stores therein the image data;
an image transfer control unit that controls transfer of the image data among the reading units, the image processing unit, and the storing unit, wherein
the image transfer control unit segments a unit of a process for each image process request, and causes the image processing unit to carry out an image process on the image data from the reading units.

2. The image processor according to claim 1, wherein the reading unit includes a scanner charge-coupled device and a contact image sensor.

3. The image processor according to claim 1, wherein in a case of double-side simultaneous reading in which the image data is stored temporarily in the storing unit and a front side image and a back side image are output in this order, the image transfer control unit sets a parameter for the front side image on the image processing unit before processing of the front side image, and sets a parameter for the back side image on the image processing unit before processing of the back side image.

4. The image processor according to claim 1, wherein in a case of double-side simultaneous reading, only a difference between a parameter set for a front side image and a parameter set for a back side image is set upon setting the parameter for the back side image in changing setting of the parameters for the front side image and back side image.

5. The image processor according to claim 1, wherein, in a case of double-side simultaneous reading, a parameter for a color correction image process is changed to match a color of a front side image to that of a back side image.

6. The image processor according to claim 1, wherein, in a case of double-side simultaneous reading, a parameter for a filter image process is changed to match a modulation transfer function characteristic of a front side image to that of a back side image.

7. The image processor according to claim 1, further comprising an illegal copy determining unit that determines on whether the image data input from the reading units is illegal copy, wherein,
when causing the illegal copy determining unit to process the image data, the image transfer control unit sets a parameter for a front side image on the illegal copy determining unit before processing of the front side image, and sets a parameter for a back side image on the illegal copy determining unit before processing of the back side image.

8. The image processor according to claim 7, wherein, in a case of double-side simultaneous reading, only an image determined to be illegal copy is painted out to be unreadable.

9. The image processor according to claim 7, wherein, in a case of double-side simultaneous reading, a parameter for binarization image process is set as a threshold optimum for detecting illegal copy, and the parameter is changed for the front side image and the back side image.

10. The image processor according to claim 1, wherein, in a case of front side reading, an image process is carried out through an image process path that is same as an image process path for a front side image in a case of the double-side simultaneous reading.

11. The image processor according to claim 7, wherein, in a case of front side reading, an image process is carried out through an image process path that is same as an image process path for a front side image in a case of the double-side simultaneous reading.

12. An image forming apparatus including the image processor of claim 1.

13. An image processing method that is implemented on an image forming apparatus that includes a plurality of reading units, an image processing unit that carries out a given image process on image data acquired by each of the reading units, and a storing unit that temporarily stores therein the image data, and that causes the image processing unit to carry out an desired image process, the image processing method comprising:
segmenting a unit of a process for each image process request;
controlling image transfer timing; and
causing the image processing unit to process the image data from the reading units.

14. The image processing method according to claim 13, further comprising:
setting a parameter for a front side image of the image data input from the reading units on an illegal copy determining unit before processing of the front side image;
setting a parameter for a back side image of the image data on the illegal copy determining unit before processing of the back side image; and
causing the illegal copy determining unit to determine on whether the image data is illegal copy.

15. A computer program product comprising a computer usable medium having computer readable program codes embodied in the medium that, when executed, causes a computer to execute:
segmenting a unit of a process for each image process request;
controlling image transfer timing;
causing an image processing unit to process an image data from reading units;
setting a parameter for a front side image of the image data input from the reading units on an illegal copy determining unit before processing of the front side image;
setting a parameter for a back side image of the image data on the illegal copy determining unit before processing of the back side image; and
causing the illegal copy determining unit to determine on whether the image data is illegal copy.
